(19) United States
(12) Patent Application Publication
(10) Pub. No.: US 2026/0201110 A1
(43) Pub. Date: Jul. 16, 2026

(54) Storage-Stable Solid Rubber Epoxy Adduct

(71) Applicant: Zephyros, Inc., Romeo, MI (US)

(72) Inventors: Michael J. Czaplicki, Romeo, MI (US); Donald A. Paquet, Romeo, MI (US); Jeanne S. Bednarski, Romeo, MI (US)

(21) Appl. No.: 18/873,360

(22) PCT Filed: Jul. 10, 2023
(86) PCT No.: PCT/US2023/027298

§ 371 Date: Dec. 10, 2024

Related U.S. Application Data
(60) Provisional application No. 63/359,513, filed on Jul. 8, 2022.

(51) Int. Cl. C08G 59/42; C08G 59/24; C08J 9/00; C08J 9/10; C08L 63/00

(52) U.S. Cl. CPC C08G 59/4253; C08G 59/245; C08J 9/0061; C08J 9/103; C08L 63/00; C08J 2363/02; C08L 2203/14

(57) ABSTRACT

A solid, storage-stable, epoxy resin composition comprising the reaction product of a solid carboxylated nitrile rubber (XNBR) and an epoxy functional resin, wherein the carboxylic acid content of the carboxylated nitrile rubber is less than about 2% by weight carboxyl content.

### CLAIM OF PRIORITY

This application claims the benefit of the priority date of U.S. Provisional Application Ser. No. 63/359,513, filed on Jul. 8, 2022. The contents of that application are hereby incorporated by reference herein in their entirety and for all purposes.

### FIELD OF THE INVENTION

The present teachings relate generally to storage-stable, solid, carboxylated nitrile rubber-epoxy adducts useful in epoxy thermosets. More specifically, solid epoxy adducts from low acid percentage carboxylated nitrile rubber can be storage stable and are useful toughening agents in epoxy resin compositions.

### BACKGROUND OF THE INVENTION

Epoxy thermoset composites and adhesives are known for their both their high strength and typically high glass transition temperature (Tg). Unfortunately, these useful materials typically suffer from brittleness. While there are well established techniques to improve the fracture toughness of epoxy thermosets, it is still an area of ongoing research.

One well-established way to improve the toughness of epoxy systems is to use the liquid carboxyl terminated butadiene nitrile (CTBN) rubber in the epoxy formulation. The liquid CTBN can be used as an additive directly, but this can lead to some stability issues due to epoxy-acid reactions. In addition, resultant physical properties typically are better if a pre-reaction of the epoxy and rubber has been performed. A preferred way to do so is to adduct the CTBN with epoxy resins and use this adduct in a thermoset formulation. During curing, the rubber containing adduct becomes incompatible with curing epoxy matrix and forms separate low Tg elastomeric discontinuous domains. These domains can improve the fracture toughness of the thermoset without significantly reducing the modulus or Tg. In addition to liquid CTBN with different levels of acrylonitrile, liquid and solid adducts of CTBN, made from liquid and solid epoxy resins respectively, are readily available commercially. Because the reacting carboxyl group is at the ends of the rubber, adduction with difunctional epoxy resins leads to predominantly linear polymers. By carefully selecting the epoxy resin and epoxy resin to CTBN ratio, it is possible to control the adduct molecular weight and compatibility with the thermoset formulation components.

Using liquid CTBN-based adducts is a well-established method to toughen epoxy thermosets.

One disadvantage of CTBN is that it is a viscous liquid. For example, Hypro 1300×13 from Huntsman is a CTBN with 26% acrylonitrile and has a viscosity at 27° C. of 500,000 mPa·s. Practical handling may require heating the CTBN to be able to transfer the CTBN into reaction vessels. Unfortunately, repeated heating of CTBN may increase viscosity and shorten its shelf life. Another disadvantage of CTBN is that the method of production is particularly challenging. As such, there are few production facilities. To avoid supply disruptions, it is desirable to seek an alternative to epoxy—CTBN adducts.

A storage-stable adduct is desirable as it separates the adduct synthesis from any thermoset compounding process. The adduct can be made either in a batch or continuous format under typically elevated temperatures optimal for the epoxy-acid reaction with or without catalysts to accelerate the reaction. The subsequent epoxy rubber adduct can be used at lower temperatures, for example in twin-screw extrusion compounding. Compounding at lower temperatures is desirable to avoid premature activation of thermoset curatives. By separating manufacturing steps, more efficient processes can be used to produce rubber toughened epoxy thermosets.

Carboxylated solid nitrile rubbers (XNBRs) have been used to toughen thermoset formulations. Unlike CTBN which has a low molecular weight and carboxyl groups at the ends of the polymer chain, XNBRs are high molecular weight polymers with carboxylic groups randomly spaced along the polymer chain. This can lead to adduct gelation during synthesis or storage. XNBR has been used in epoxy thermosets directly in the formula which can lead to formulation storage stability issues (due to epoxy-acid reactions that occur over time at ambient temperature). To avoid gelation or storage stability issues one can make the adduct in-situ. This manner requires long formulation mixing times to make the adduct and limits the methods by which the thermoset formula is made and its composition.

Bascom et al. (W. D. Bascom, R. Y. Ting, R. J. Moulton, C. K. Riew, and A. R. Siebert, J. of Mat. Sci., 16, 2657-2664, 1981) used CTBN- and XNBR-epoxy adducts separately and in combination to demonstrate their effectiveness in improving the fracture toughness of epoxy thermosets. Solvent was used to make the XNBR adduct using liquid epoxy which requires removal of the solvent prior to use. Only liquid epoxy resins were used in the adduct synthesis and there was no disclosure of the material state (solid or liquid) of the adduct. Additionally, no mention of adduct stability was made.

U.S. Pat. No. 3,707,583 discloses the use of carboxyl containing nitrile rubber adducts in solid composite thermoset mixtures. Solid XNBR is included in the list of potential rubbers for adduction, but the examples only contain liquid CTBN-based adducts. Solid XNBR is used as an unreacted ingredient in the compounded thermoset mixture. No mention of stability was made.

U.S. Pat. No. 6,013,730 discloses an XNBR-containing adduct made in-situ with solvent. No attempt to isolate the adduct was made. Additionally, only in-situ adducts made with XNBR and liquid polyfunctional epoxies with average functionality of three or greater are identified.

U.S. Pat. No. 6,586,089 discloses the use of CTBN containing adducts. They mention a solid adduct but do not mention a solid rubber. In fact, Line 44-48 specifies the rubber also contains terminal groups that will react with an epoxide to form a covalent bond thereto.

U.S. Pat. No. 6,846,559 discloses the utility of an epoxy-elastomer adduct. Their preferred is an epoxy-CTBN and their examples are with solid epoxy resins and CTBN. There are no examples of a solid adduct from epoxy and XNBR.

US Patent Publication No. 2004/0204551 discloses the manufacture of solid adduct made from XNBR and solid epoxy resins without solvent. The inventors discuss the need to have complete reaction to improve storage stability but provide no stability data for the adduct examples given.

U.S. Pat. No. 10,150,897 discloses the use of XNBR epoxy adducts with molecular weights greater than 60,000 Da in a crash-toughened pumpable adhesive. All the examples use liquid adducts comprising liquid epoxy resins and small amounts (~5% by wt.) of XNBR resin to enable the creation of an ingredient capable of being used in non-solid uncured compositions.

It is therefore desirable to have a solid epoxy-XNBR adduct that can be used as a separate ingredient to toughen an epoxy thermoset where the percentage of adduct is not limited and does not produce shelf-life instability prior to curing.

### SUMMARY OF THE INVENTION

Storage-stable solid XNBR-epoxy adducts can be produced from carboxylated nitrile rubber with low acid content. These adducts provide toughening in epoxy thermoset composites and adhesives. The teachings herein are directed to a solid, storage-stable, epoxy resin composition comprising the reaction product of a solid carboxylated nitrile rubber (XNBR) and an epoxy functional resin. The carboxylic acid content of the carboxylated nitrile rubber is less than about 2% by weight carboxyl content.

The carboxyl content may be less than 1% by weight. The XNBR content may be at least 10% by weight.

The epoxy functional resin may be a solid. The epoxy functional resin my comprise a liquid epoxy resin.

The reaction product may be formed in the presence of a solvent. The reaction product may be formed in the absence of any solvent.

The epoxy resin composition may be adapted to be foamed upon exposure to a stimulus.

The epoxy resin composition may be adapted to be cured upon exposure to a stimulus.

The XNBR may have a Mooney viscosity of 40-50 MU at 100° C. when tested in accordance with ISO 289.

The XNBR may have an acrylonitrile content of at least 30% by weight. The XNBR may have an acrylonitrile content of less than 40% by weight.

The composition may include more than one type of epoxy functional resin.

The composition may include at least two solid epoxy functional resins.

The composition may include at least one solid epoxy functional resins and at least one liquid epoxy functional resin.

The composition may include a polymeric particle component.

The reaction product may form an adduct which is added to the composition. The reaction product may include a PVB component.

The ratio of XNBR to epoxy functional resin may be about 1 part XNBR:3 parts epoxy functional resin to 1 part XNBR:4 parts epoxy functional resin.

The teachings herein are also directed to a foamable composition comprising a reaction product of a solid carboxylated nitrile rubber (XNBR) and an epoxy functional resin, a foaming agent, a curing agent, and an optional polymeric particle.

The carboxylic acid content of the carboxylated nitrile rubber may be less than about 2% by weight carboxyl content.

The foaming agent may cause foaming upon exposure to a stimulus.

The curing agent may cause curing upon exposure to a stimulus.

The carboxyl content may be less than 1% by weight.

The XNBR content may be at least 10% by weight.

The reaction product may be a solid at room temperature (e.g., 20° C. to 25° C.).

The composition may have an increased tensile modulus as compared to the same composition where the reaction product is formed with CTBN instead of XNBR.

The composition may have an increased tensile strain at break as compared to the same composition where the reaction product is formed with CTBN instead of XNBR.

The composition may have an increased tensile strength at break as compared to the same composition where the reaction product is formed with CTBN instead of XNBR.

The composition may have an increased lap shear strength as compared to the same composition where the reaction product is formed with CTBN instead of XNBR.

The composition may have an increased average peel strength as compared to the same composition where the reaction product is formed with CTBN instead of XNBR.

The teachings herein are further directed to use of the composition of any of the preceding claims to adhere to an oil coated substrate.

The teachings herein are also directed to use of the composition of any of the preceding claims to adhere to a substrate in a cavity of a transportation vehicle.

### BRIEF DESCRIPTION OF THE DRAWINGS

FIG. 1 shows a graph depicting the melt flow index as a function of aging for an exemplary material in accordance with teachings herein.

FIG. 2 shows a graph depicting the melt flow index as a function of aging for an exemplary material in accordance with teachings herein.

FIG. 3 shows a graph depicting the melt flow index as a function of aging for an exemplary material in accordance with teachings herein.

### DETAILED DESCRIPTION OF THE INVENTION

The present teachings meet one or more of the above needs by the improved compositions and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

One aspect of the current teachings comprises a solid epoxy composition, useful as a toughening agent in epoxy formulations, comprising the reaction product of an XNBR of low acid content and an epoxy resin. Preferably, the percent carboxylic acid content (percent by weight COOH) in the XNBR is less than 2% and most preferably less than 1%. It may be possible to consume sufficient acid content of XNBRs of higher acid content prior to reacting with epoxy resins. It is preferable, however, to use an XNBR with low acid content to simplify the overall reaction process. Krynac X 146 from Arlanxeo is an exemplary XNBR with a carboxyl content of 0.5%.

The adduct may be made with liquid epoxy resins but may require solid additives to ensure the completed adduct is a friable solid if the desire is to have a thermoset ingredient that is solid at room temperature. It is easier to use solid epoxy resins when reacting with the XNBR because mixing of the constituents prior to reaction is simplified. Liquid epoxy resins can be a part of the adduction reaction or added post-reaction to adjust the softening temperature of the adduct or change the ratio of epoxide to carboxyl functionality to provide greater epoxide excess. Herein we define an epoxy resin as a resin with at least two epoxy groups.

The adduct can be made in a batch or continuous process. Double arm sigma mixers, single screw extruders, twin screw extruders, and continuous kneaders are just a few non-limiting examples of equipment that can be used to produce adduct.

The adduct may be made at elevated temperatures of preferably 80° C.-250° C., more preferably 100° C.-200° C. and most preferably 110° C.-165° C. The reaction is carried out in the melt state and the minimum temperature must be above the softening point of the reacting mixture. Solvent can be used to lower the softening point as well as the viscosity of the reacting mixture. The solvent may have to be removed for the finished adduct to be a friable solid and produce 100% solid formulated compositions. It is preferable, however, to perform the reaction in the molten state in the absence of solvents. Epoxy-acid reaction catalysts, known in the art, can be used but are not necessary. Phosphines, such as triphenyl phosphine, tertiary amines, such as dimethylbenzyl amine, quarternary ammonium and phosphonium compounds such as ethyltriphenyl phosphonium iodide are a non-limiting list of potential catalysts.

The adduct mixture can contain inert fillers. Metal carbonates such as calcium carbonate, silicates such as wollastonite or Garamite, clays such as kaolin, fumed silica, are a non-limiting list of inorganic fillers. Thermoplastic polymers such as polyvinyl butyral, phenoxy resins, polycarbonate, and ethylene co- and ter-polymers can also be part of the mixture. Other common thermoset ingredients such as pigments, UV absorbers or stabilizers, radical scavengers, antioxidants are permissible.

The compositions described herein may include at least one type of polymeric particle. Such polymeric particles may be utilized to improve fracture toughness (G_{1C}), peel resistance and impact resistance. As used herein, like with any other ingredients of the present teachings, the term “polymeric particle” can include one or more types of polymeric particles. Various types of polymeric particles may be employed in the practice of the present teachings and often include one or more elastomers. It is generally preferable for the polymeric particles to be at least 4%, more typically at least 7%, even more typically at least 10%, and even more typically at least 13% by weight of the activatable material and also preferable for the polymeric particle to be less than 90%, more typically less than 40% an even more typically less than 30% by weight of the activatable material, although higher or lower amounts may be used in particular embodiments.

The polymeric particle may include one or more core/shell polymers which may be pre-dispersed in an epoxy. The process for forming the core shell materials in a liquid epoxy avoids agglomeration of the core shell particles as may be common with “dry” core shell polymeric particles (e.g., agglomeration may occur during the drying process). An example of products made by this process may be described in one or more of U.S. Pat. Nos. 3,984,497; 4,096,202; 4,034,013; 3,944,631; 4,306,040; 4,495,324; 4,304,709; and 4,536,436. The polymeric particles may be formed through an emulsion polymerization process. This process may include the addition of a solvent to the resin. As a result of incompatibility between the resin/solvent and water, the water settles out of the material as the core shell particles move into the resin, resulting in reduced agglomeration. Alternatively, high speed dispersing equipment can be effective at de-agglomerating core/shell materials. However, a surfactant may remain post spray drying or coagulating the core/shell material. This residual surfactant may be detrimental for the material's resistance to environmental exposure conditions that involve water such as salt spray and humidity. Materials not exposed to the environmental exposure conditions would typically not show a difference between dry core shell and liquid core shell masterbatch provided that there is sufficient de-agglomeration of the dry material.

As used herein, the term core shell polymer may denote a polymeric material wherein a substantial portion (e.g., greater than 30%, 50%, 70% or more by weight) thereof may be comprised of a first polymeric material (i.e., the first or core material) that may be substantially entirely encapsulated by a second polymeric material (i.e., the second or shell material). The first and second polymeric materials, as used herein, may be comprised of one, two, three or more polymers that are combined and/or reacted together (e.g., sequentially polymerized) or may be part of separate or same core/shell systems. The core/shell polymer should be compatible with the formulation and preferably has a ductile core and a rigid shell which has favorable adhesion with the other components of the activatable material.

Examples of useful core/shell polymers include but are not limited to those sold under the tradename, Kane Ace, commercially available from Kaneka. Particularly preferred grades of Kane Ace core/shell are sold under the designations MX-257 and M711 or Clear Strength E-950 available from Arkema. The core shell polymer particulate may be from about 4% to about 20% by weight of the activatable material.

The compositions may include a curing agent in the range of about 0.1% to about 5.0% by weight of the material. The material may include a foaming agent. The foaming agent may be a physical foaming agent. The foaming agent may be a chemical foaming agent. The material may include a foaming agent in the range of about 0.1% to about 5.0% by weight of the material. The material may include a flexibilizer.

The foaming agent may include one or more nitrogen containing groups such as amides, amines and the like. Nonlimiting examples of suitable blowing agents include azodicarbonamide, dinitrosopentamethylenetetramine, 4,4ᵢ-oxy-bis-(benzenesulphonylhydrazide), trihydrazinotriazine and N,Nᵢ-dimethyl-N,Nᵢ-dinitrosoterephthalamide. The material may include a physical foaming agent, including but not limited to agents such as Expancel® available from Nouryon. Alternatively, the material may be manufactured according to the MuCell® process available from Trexel.

An accelerator for the foaming agents may also be provided in the compositions herein. Various accelerators may be used to increase the rate and/or reduce the temperature at which the blowing agents form inert gases. One preferred blowing agent accelerator is a metal salt, or is an oxide, e.g., a metal oxide, such as zinc oxide. Other preferred accelerators include modified and unmodified thiazoles, ureas and imidazoles.

It is possible that the curing agents assist the compositions herein in curing by crosslinking of the polymers, epoxy resins or both. It is also possible for the curing agents to assist in advancing or chain extending the compositions. Useful classes of curing agents are materials selected from aliphatic or aromatic amines or their respective adducts, amidoamines, polyamides, cycloaliphatic amines, anhydrides, polycarboxylic polyesters, isocyanates, phenol-based resins (e.g., phenol or cresol novolak resins, copolymers such as those of phenol terpene, polyvinyl phenol, or bisphenol-A formaldehyde copolymers, bishydroxyphenyl alkanes or the like), or mixtures thereof. Particularly preferred curing agents include modified and unmodified polyamines or polyamides such as triethylenetetramine, diethylenetriamine tetraethylenepentamine, cyanoguanidine, dicyandiamides and the like.

One or more curing agents and/or curing agent accelerators may be added to the compositions. Amounts of curing agents and curing agent accelerators can vary widely within the compositions depending upon the desired rate of curing, the desired cellular structure, the desired structural properties of the compositions and the like. Exemplary ranges for the curing agents or curing agent accelerators present in the compositions range from about 0.001% by weight to about 7% by weight.

An accelerator for the curing agents (e.g., a modified or unmodified urea such as methylene diphenyl bis-urea, an imidazole or a combination thereof) may also be provided for preparing the compositions.

An example of a suitable curing agent may be a polyamine curing agent such as Amicure® CG 1200 (i.e., micronized dicyandiamide) available from Evonik Resource Efficiency GmbH. An example of a suitable curing accelerator may be a substituted urea accelerator such as Omicure® U-52M (i.e., phenyl substituted urea) available from Huntsman Corporation.

The compositions described herein may also include one or more reinforcement components. Preferably the reinforcement components include a material that is generally non-reactive with the other components present in the compositions. It is contemplated that the reinforcement components may also impart properties such as strength and impact resistance to the compositions.

Examples of reinforcement components include wollastonite, silica, diatomaceous earth, glass, clay (e.g., including nanoclay), glass beads or bubbles, glass, carbon or ceramic fibers, nylon, aramid or polyamide fibers, and the like. The one or more reinforcement components may be selected from mineral reinforcements such as diatomaceous earth, clay (e.g., including nanoclay), pyrophyllite, sauconite, saponite, nontronite, wollastonite, or montmorillonite. The reinforcement component may include a silica and/or calcium mineral reinforcement. The reinforcement component may include glass, glass beads or bubbles, carbon or ceramic fibers, nylon, aramid or polyamide fibers (e.g., Kevlar). The reinforcement component may be wollastonite. The reinforcement component may be a fiber with an aspect ratio of from about 20:1 to about 3:1. The reinforcement component may be a fiber with an aspect ratio of from about 15:1 to about 10:1. The reinforcement component may be a fiber with an aspect ratio of about 12:1. It is possible that the reinforcement component improves a first physical characteristic while simultaneously substantially avoiding any significant detrimental effect on a second physical characteristic. As one example, the selected reinforcement component may improve the overall tensile modulus of the compositions while still having minimal detrimental effect on strain to failure. The compositions may further include one or more fillers including pigments or colorants, calcium carbonate, talc, silicate minerals, vermiculite, mica, or the like.

When employed, the reinforcement components in the compositions can range from 10% or less to 90% or greater by weight of the compositions, but more typical from about 20% to 55% by weight of the compositions. According to some embodiments, the compositions may include from about 0% to about 30% by weight, and more preferably slightly less than 10% by weight reinforcement components.

It is contemplated that most nearly any additional chemicals, materials or otherwise may be added to the activatable material assuming they are suitable for the compositions and suitable for a chosen application of the compositions.

Other additives, agents or performance modifiers may also be included in the compositions as desired, including but not limited to a UV resistant agent, a flame retardant, a heat stabilizer, a colorant, a processing aid, a lubricant or the like.

### Examples

Materials used in the examples are listed below at table A:

TABLE A

| | |
|---|---|
| Amicure CG325 | a pulverized grade of dicyandiamide available from Evonik |
| Krynac X 146 | a solid carboxylated nitrile rubber with 32% acrylonitrile and 0.5% |
| | carboxylic acid, available from Arlanxeo; |
| Krynac X 160 | a solid carboxylated nitrile rubber with 32% acrylonitrile and 0.5% |
| | carboxylic acid, available from Arlanxeo; |
| Nipol 1472X | a solid carboxylated nitrile rubber with 27% acrylonitrile, available from |
| | Zeon Corp - Nipol 1472X has 0.075 acid equivalents per one hundred |
| | grams of resin. This corresponds to (0.075/100 × 45) = 3.375 g |
| | COOH/100 g or 3.375% carboxylic acid; |
| Cellcom AC7001 | azodicarbonamide blowing agent available from Kum Yang Co. Ltd. |
| DER 661 | a solid bisphenol A based epoxy available from Olin Corp |
| Hypro 1300x13 | a liquid CTBN rubber with 26% acrylonitrile available from Huntsman |
| KaneAce MX257 | a core/shell rubber toughening agent, dispersed in liquid bisphenol A |
| | epoxy, available from Kaneka |
| KD-214C | a solid bisphenol A based epoxy resin available from Kukdo Chemical |
| | Co, Ltd |
| Omnicure U52M | a urea-based accelerator available from Huntsman |
| PVB | a thermoplastic polyvinyl butyral grade B08HX, available from Chang |
| | Chun Group |
| TMEP-70ASP | a 70% (by weight) blend of phenoxy resin with liquid bisphenol A epoxy, |
| | available from Springfield Industries |
| YD-017 | a solid bisphenol A based epoxy resin available from Kukdo Chemical |
| | Co, Ltd. |
| YD-019 | a solid bisphenol A based epoxy resin available from Kukdo Chemical |
| | Co, Ltd. |
| YD-128 | a liquid Bisphenol A based epoxy resin available from Kukdo Chemical |
| | Co. Ltd. |
| 61MALHCL | ferrocote 61 MAL HCL 1 lubricant, available from Quaker Houghton |

Example 1: To a jacketed double arm mixer tempered by a hot oil temperature control unit (TCU) set at 350° F., 450 parts of Krynac X 146 is added to the mixer and masticated for several minutes. Then 675 parts of YD-017 solid epoxy resin is added all at once and the system mixed until the epoxy resin melts and forms a homogenous mixture. Then 675 parts of YD-019 epoxy are added in four parts over five minutes. After fifty minutes of mixing the TCU setpoint is lowered to 340° F. and the mixture mixes for an additional three hours. This maintains the mixture temperature at 315° F.-325° F. Next, the TCU setpoint is lowered to 300° F. and 200 parts of YD-128, liquid epoxy resin is added over five minutes. Mixing continues for an additional 30 minutes. The TCU setpoint is lowered to 250° F. and the adduct is pulled from the mixer and quickly cooled to room temperature. The material is a friable solid upon cooling.
Example 2: To the setup described in Example 1 with the TCU set at 330° F., 450 parts of Krynac X 160 solid rubber is added and masticated for about 35 minutes. Then 675 parts of YD-017 solid epoxy resin is added all at once and the system mixes until the epoxy resin melts and forms a homogenous mixture. Then 675 parts of YD-019 epoxy are added over a 5 minute span. After an additional ten minutes of mixing, the mixture appears homogeneous. After one hour of mixing the TCU setpoint is lowered to 340° F. and the mixture mixes for an additional three hours. This maintains the mixture temperature at 315° F.-325° F. Next, the TCU setpoint is lowered to 300° F. and 200 parts of YD-128 liquid epoxy resin are added over a five minute span. Mixing continues for an additional 60 minutes. The TCU setpoint is lowered to 250° F., the adduct is pulled from the mixer and quickly cooled to room temperature. The material is a friable solid upon cooling to room temperature.
Example 3: To the setup described in Example 1 with the TCU set at 330° F., 630 parts of Krynac X 146 are added to the mixer and masticated for several minutes. Then 990 parts of YD-017 are added over several minutes to yield a homogeneous mixture. Mixing continues for an additional three hours. The TCU setpoint is reduced to 300° F. and 180 parts of YD-128 are added over 13 minutes. Mixing continues for another 60 minutes, after which the TCU setpoint is lowered to 250° F. and the mixture is removed from the mixer. The mixture is cooled quickly to yield a friable solid.
Example 4: To the setup described in Example 1 with the TCU set to 250° F., 500 parts of Krynac X 146 is added to the mixer and masticated for five minutes. Subsequently 750 parts of Kukdo KD-214C epoxy is added over 8 minutes to obtain a homogeneous mixture. Next the TCU setpoint is increased to 270° F. and an additional 750 parts of KD-214C is added over 8 minutes. The TCU setpoint is then increased to 320° F. and mixing continues for 53 minutes. Next, the TCU setpoint is increased to 330° F. and mixing continues for 150 minutes. The material is then pulled out of the mixer and quickly cooled to yield a friable solid.
Example 5: To the mixer described in Example 1, with the TCU setpoint at 350° F., 450 parts of Krynac X 146 are added to the mixer and masticated for three minutes. Then 675 parts of YD-017 are added over a five minute span. Next, 675 parts of YD-019 are added over a five minute span to achieve a homogeneous mixture. After four hours of mixing, the TCU setpoint is lowered to 300° F. and 200 parts of YD-128 are added over a five minute span. The material is mixed for an additional fifteen minutes. Then the TCU setpoint is lowered to 275° F. and 10 parts of Irganox 1010 antioxidant are added. Mixing continues for five minutes. The adduct is then pulled out of the mixer and cooled quickly to yield a friable solid.
Example 6: To the mixer described in Example 1, with the TCU setpoint at 350° F., 450 parts of Krynac X 146 are added to the mixer and masticated for three minutes. Then 675 parts of YD-017 are added over a five minute time span. Next, 675 parts of YD-019 are added over a five minute span to achieve a homogeneous mixture. Then 200 parts of YD-128 are added over a five minute span. After one hour of mixing the TCU setpoint is lowered to 340° F. The material is mixed for an additional three hours. Then the TCU setpoint is lowered to 250° F. The material is mixed for an additional twenty minutes. The adduct is then pulled out of the mixer and cooled quickly to yield a friable solid.
Example 7: In a manner like that described in Example 1, an adduct of the following composition is prepared with one addition. The thermoplastic polyvinyl butyral (PVB) is added after the YD-128 was incorporated and mixed for several minutes to ensure a homogeneous mixture. The mixture is then removed from the mixer and quickly cooled to room temperature to yield a friable solid. The composition is shown below at table B.

TABLE B

| Material | Weight % |
|---|---|
| Krynac X 146 | 19.33 |
| YD-017 | 28.99 |
| YD-019 | 28.99 |
| YD-128 | 8.59 |
| PVB | 14.10 |

Example 8: To a setup like one described in Example 1 with the TCU set to 320° F., 9800 parts of Krynac X 146 are added to the mixer and masticated for ten minutes. Subsequently, 4200 parts of Kukdo KD-214C epoxy are added over fifteen minutes to obtain a homogeneous mixture. Mixing continues over 150 minutes while the TCU setpoint is adjusted to maintain a mixture temperature of 280° F. The material was then pulled out of the mixer and quickly cooled to yield a friable solid.
Example 9: To the same setup described in Example 1 with the TCU set to 180° F., 480 parts of Nipol 1472X are masticated for about five minutes. Then 760 parts of DER 661 solid epoxy resin is added over a period of four minutes. The TCU setpoint is increased to 200° F. and an additional 760 parts of DER 661 are added over 13 minutes to make a homogenous dispersion. The TCU setpoint is increased to 300° F. After one hour, the mixture gels. This example demonstrates that even with the increased amount of epoxide functionality from the lower molecular weight epoxy resin DER 661, the higher acid functionality of Nipol 1472X leads to unstable adducts. See table A of US2004/0204551 where a similar composition is formed. This example indicates that the composition listed in table A of US2004/0204551 was not fully reacted and that gelation would occur if it were.

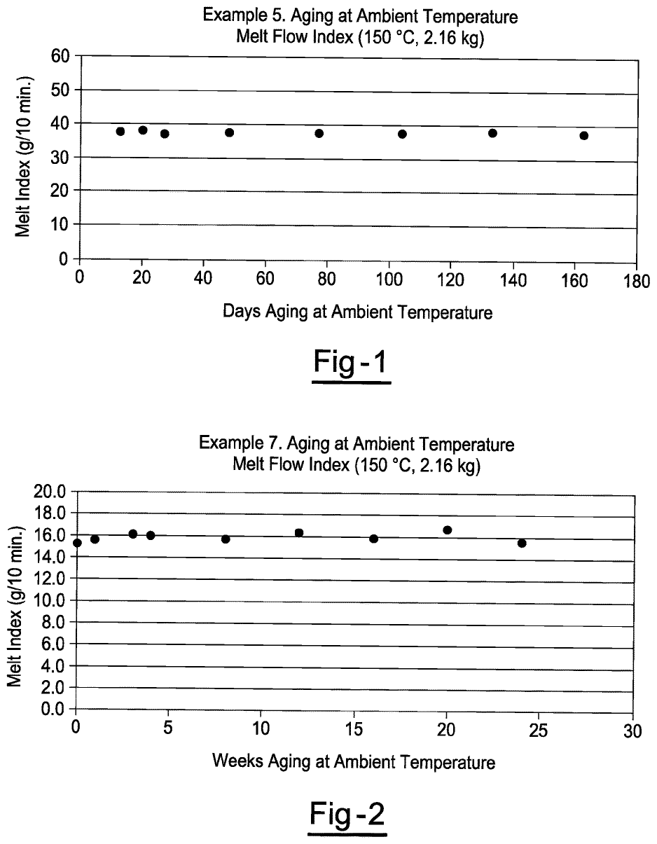

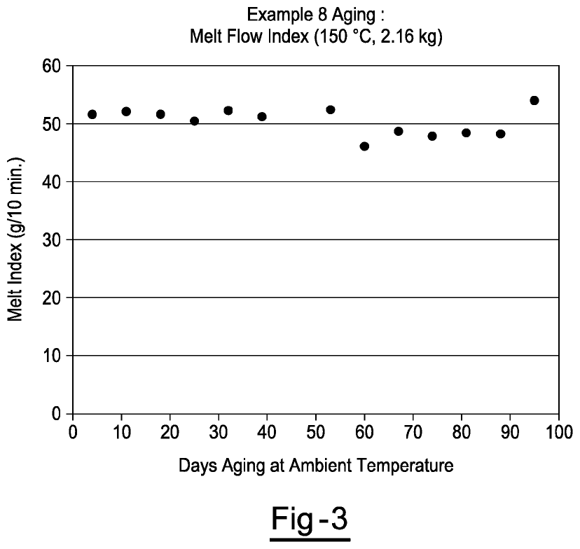

To address the storage stability, the melt flow index (Dynisco model LMI 4000 @150° C., 2.16 kg) was monitored for the adduct in Example 5 stored at ambient temperature. FIG. 1 demonstrates only a small decrease in the melt index. Typically, a decrease in the melt index over time would indicate continued advancement or reaction of the polymer. Similarly, the robust storage stability of Example 7 is shown in FIG. 2. FIGS. 1 and 2 demonstrate the storage stability of a solid rubber adduct with higher molecular weight epoxy. FIG. 3 shows the storage stability of Example 8, indicating that even with lower molecular weight epoxy resins, solid rubber adducts made with a rubber of low acid content are stable.

The composition of two solid adducts, one from liquid CTBN and one from solid XNBR, made in a manner like Example 1, follows. In Example 10, the YD-017 and YD-019 are added first and melted prior to the addition of the Hypro 1300×13. The compositions are shown below at table C.

TABLE C

| | Example 10 | Example 11 |
|---|---|---|
| Material | composition (wt %) | composition (wt %) |
| YD-017 | 33.75 | 35.00 |
| YD-019 | 33.75 | 35.00 |
| Hypro 1300x13 | 22.50 | |
| Krynac X 146 | | 20.00 |
| YD-128 | 10.00 | 10.00 |
| Total | 100.00 | 100.00 |

The adducts of Examples 10 and 11 are formulated into a foamable structural adhesive of the following compositions (Examples 12 and 13) shown at table D.

TABLE D

| | Example 12 | Example 13 |
|---|---|---|
| Material | composition (wt %) | composition (wt %) |
| Example 10 | 54.97 | |
| Example 11 | | 54.97 |
| TMEP70ASP | 10.00 | 10.00 |
| KaneAce MX257 | 25.00 | 25.00 |
| Kevlar Masterbatch* | 5.00 | 5.00 |
| Cellcom AC7001 | 2.00 | 2.00 |
| Amicure CG-325G | 2.40 | 2.40 |
| Omicure U52M | 0.60 | 0.60 |
| Pigment | 0.03 | 0.03 |
| Total | 100.00 | 100.00 |

*20% of chopped and fibrillated aramid fiber compounded with 80% type 1 epoxy resin.

Evaluation of the foaming adhesives of Examples 12 and 13, cured at 163° C. for 30 minutes, yielded the following properties shown at table E.

TABLE E

| Property | Example 12 | Example 13 |
|---|---|---|
| Volume expansion (%) | 231 | 249 |
| Uncured density (g/cm3) | 1.15 | 1.14 |
| Cured density (g/cm3) | 0.35 | 0.32 |
| Tensile modulus (MPa) | 747 | 808 |
| Tensile strain at break (%) | 5.2 | 7.8 |
| Tensile strength at break (MPa) | 15.2 | 18.6 |
| Lap shear strength (MPa)*, | 2.22 | 3.02 |
| Average peel strength (N/mm)** | 4.3 | 4.7 |

*0.030″ EG60, test speed: 254 mm/min, bondline 3 mm;
**0.060″ EG60, test speed: 50.4 mm/min, bondline 1.5 mm, 2.5-3.0 mg/in² FERROCOTE ® 61 MAL HCL;

Table E demonstrates that the XNBR-based adduct provides equal or better performance when compared to the CTBN-based adduct. In particular, the peel strength of Example 13 at a slightly lower rubber elastomer content indicates equal or better toughness for XNBR adducts.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize, however, that certain modifications would come within the teachings of this invention. Therefore, the following claims should be studied to determine the true scope and content of the invention.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

1: A solid, storage-stable, epoxy resin composition comprising the reaction product of:
(i) a solid carboxylated nitrile rubber (XNBR); and
(ii) an epoxy functional resin;
wherein the carboxylic acid content of the carboxylated nitrile rubber is less than about 2% by weight carboxyl content.

2: The composition of claim 1, wherein the carboxyl content is less than 1% by weight.

3: The composition of claim 1, wherein the XNBR content is at least 10% by weight.

4-5. (canceled)

6: The composition of claim 1, wherein the reaction product is formed in the presence of a solvent.

7: The composition of claim 1, wherein the reaction product is formed in the absence of any solvent.

8: The composition of claim 3, wherein the epoxy resin composition is adapted to be foamed and/or cured upon exposure to a stimulus.

9. (canceled)

10: The composition of claim 8, wherein the XNBR has a Mooney viscosity of 40-50 MU at 100° C. when tested in accordance with ISO 289.

11: The composition of claim 1, wherein the XNBR has an acrylonitrile content of at least 30% by weight.

12: The composition of claim 1, wherein the XNBR has an acrylonitrile content of less than 40% by weight.

13. (canceled)

14: The composition of claim 3, wherein the composition includes at least two solid epoxy functional resins.

15: The composition of claim 3, wherein the composition includes at least one solid epoxy functional resins and at least one liquid epoxy functional resin.

16. (canceled)

17: The composition of claim 1, wherein the reaction product forms an adduct which is added to the composition.

18: The composition of claim 1, wherein the reaction product includes a PVB component.

19: The composition of claim 8, wherein the ratio of XNBR to epoxy functional resin is about 1 part XNBR:3 parts epoxy functional resin to 1 part XNBR:4 parts epoxy functional resin.

20: A foamable composition comprising:
(i) a reaction product of a solid carboxylated nitrile rubber (XNBR) and an epoxy functional resin;
(ii) a foaming agent;
(iii) a curing agent; and
(iv) an optional polymeric particle.

21: The composition of claim 20, wherein the carboxylic acid content of the carboxylated nitrile rubber is less than about 2% by weight carboxyl content.

22-33. (canceled)

34: The composition of claim 20, wherein the composition includes at least two solid epoxy functional resins.

35: The composition of claim 20, wherein the composition includes at least one solid epoxy functional resins and at least one liquid epoxy functional resin.

36-39. (canceled)

40: The composition of claim 20, wherein the reaction product is solid at room temperature (e.g., 20° C. to 25° C.).

41-47. (canceled)

48: A vehicle body component having an oily surface and including the composition of claim 1.
